(19) United States
(12) Patent Application Publication
(10) Pub. No.: US 2025/0124919 A1
(43) Pub. Date: Apr. 17, 2025

(54) VOICE RECOGNITION APPARATUS, VEHICLE, NON-TRANSITORY COMPUTER READABLE MEDIUM, AND CONTROL METHOD

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Ryota YANAGISAWA, Ota-ku Tokyo-to (JP); Akira MIYAMOTO, Nisshin-shi Aichi-ken (JP); Eiichi MAEDA, Asaka-shi Saitama-ken (JP); Haruto TOYAMA, Nagoya-shi Aichi-ken (JP); Kotaro HIROSE, Nisshin-shi Aichi-ken (JP); Yasuhiro KOBATAKE, Nagoya-shi Aichi-ken (JP)

(73) Assignee: TOYOTA JIDOSHA KABUSHIKI KAISHA, Toyota-shi Aichi-ken (JP)

(21) Appl. No.: 18/898,924

(22) Filed: Sep. 27, 2024

(30) Foreign Application Priority Data
Oct. 13, 2023 (JP) 2023-177804

(51) Int. Cl. G10L 15/22; B60W 50/14

(52) U.S. Cl. CPC G10L 15/22; B60W 50/14; B60W 2050/146; G10L 2015/223

(57) ABSTRACT

A voice recognition apparatus includes a controller that is configured to control a specific function in response to voice input from an occupant of a vehicle, and that is configured to sequentially transition to each of multiple states within a transition period from accepting the voice input until at least finishing controlling the specific function, and display, on a screen, which of the multiple states the controller is in.

### CROSS-REFERENCE TO RELATED APPLICATION

This application claims priority to Japanese Patent Application No. 2023-177804 filed on Oct. 13, 2023, the entire contents of which are incorporated herein by reference.

### TECHNICAL FIELD

The present disclosure relates to a voice recognition apparatus, a vehicle, a program, and a control method.

### BACKGROUND

Patent Literature (PTL) 1 discloses a method of supporting voice dialog for operating automobile functions. In this method, non-voice signals are output as acoustic signals depending on the state of a voice control system, such as a “voice output” state, “voice input” state, or “processing” state.

### CITATION LIST

### Patent Literature

PTL 1: JP 2007-503599 A

### SUMMARY

In the conventional method, a user cannot recognize the state of an apparatus after the user's voice input because there is no response from the apparatus in a state corresponding to “processing”.

It would be helpful to allow the user to recognize multiple states, after the user's voice input, while the apparatus is performing information processing.

A voice recognition apparatus according to the present disclosure includes a controller configured to control a specific function in response to voice input from an occupant of a vehicle, the controller being configured to sequentially transition to each of multiple states within a transition period from accepting the voice input until at least finishing controlling the specific function, and display, on a screen, which of the multiple states the controller is in.

A control method according to the present disclosure includes:
controlling, by a computer, a specific function in response to voice input from an occupant of a vehicle;
sequentially transitioning, by the computer, to each of multiple states within a transition period from accepting the voice input until at least finishing controlling the specific function; and displaying, by the computer on a screen, which of the multiple states the computer is in.

According to the present disclosure, the user can recognize the multiple states, after the user's voice input, while the apparatus is performing information processing. This improves convenience.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a voice recognition apparatus according to the embodiment of the present disclosure;

FIG. 3 is a flowchart illustrating operations of the voice recognition apparatus according to the embodiment of the present disclosure; and

FIG. 4 is a state transition diagram illustrating multiple states of the voice recognition apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

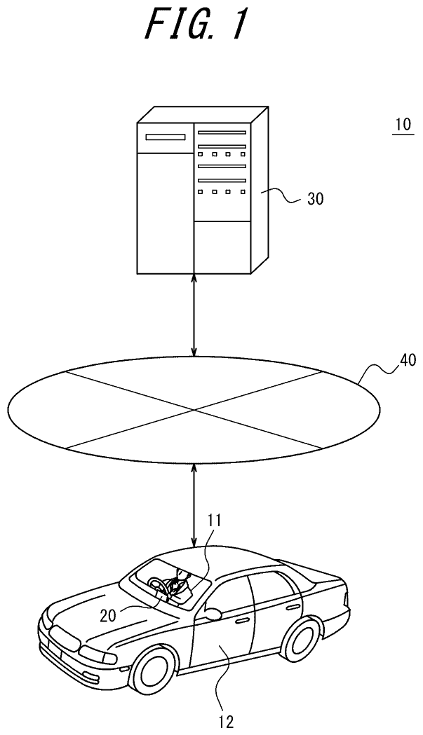

A configuration of a system 10 according to the present embodiment will be described with reference to FIG. 1.

The system 10 according to the present embodiment includes a voice recognition apparatus 20 and a server apparatus 30. The voice recognition apparatus 20 can communicate with the server apparatus 30 via a network 40.

The voice recognition apparatus 20 is a computer that is installed in a vehicle 12 and that has a voice recognition function. The voice recognition apparatus 20 is used by a user 11. The user 11 is an occupant of the vehicle 12.

The server apparatus 30 is a computer that belongs to a cloud computing system or other computing system installed in a facility such as a data center. The server apparatus 30 is operated by a service provider, such as a web service provider.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12 may be driven by the user 11, or the driving may be automated at any level. The automation level is, for example, any one of Level 1 to Level 5 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The voice recognition apparatus 20 controls a specific function Fp in response to voice input from the user 11. The voice recognition apparatus 20 sequentially transitions to each of multiple states Ts within a transition period Pt from accepting the voice input until at least finishing controlling the specific function Fp. The voice recognition apparatus 20 displays, on a screen, which of the multiple states Ts the voice recognition apparatus 20 is in.

According to the present embodiment, the user 11 can recognize the multiple states Ts, after the voice input of the user 11, while the voice recognition apparatus 20 is performing information processing. This improves convenience.

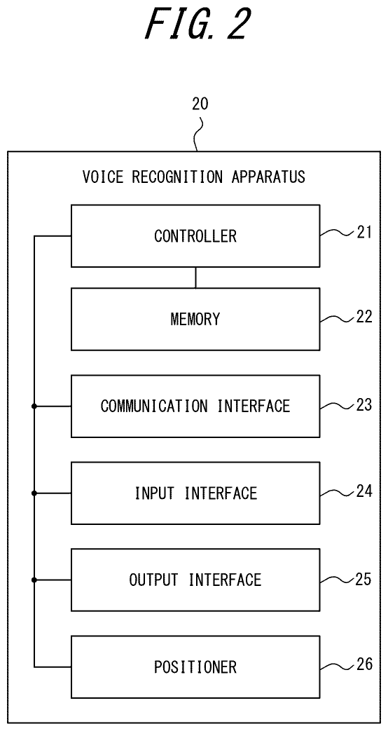

A configuration of the voice recognition apparatus 20 according to the present embodiment will be described with reference to FIG. 2.

The voice recognition apparatus 20 includes a controller 21, a memory 22, a communication interface 23, an input interface 24, an output interface 25, and a positioner 26.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the voice recognition apparatus 20 while controlling the components of the voice recognition apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the voice recognition apparatus 20 and information obtained by the operations of the voice recognition apparatus 20.

The communication interface 23 includes at least one communication module. The communication module is, for example, a module compatible with a mobile communication standard such as LTE, the 4G standard, or the 5G standard, or a wireless LAN communication standard such as IEEE802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 communicates with the server apparatus 30. The communication interface 23 receives information to be used for the operations of the voice recognition apparatus 20 and transmits information obtained by the operations of the voice recognition apparatus 20.

The input interface 24 includes at least one input device. The input device is, for example, a physical key, a capacitive key, a pointing device, a touch screen integrally provided with a display, a visible light camera, a depth camera, a LiDAR sensor, or a microphone. The term “LiDAR” is an abbreviation of light detection and ranging. The input interface 24 accepts an operation for inputting information to be used for the operations of the voice recognition apparatus 20. The input interface 24, instead of being included in the voice recognition apparatus 20, may be connected to the voice recognition apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs information obtained by the operations of the voice recognition apparatus 20. The output interface 25, instead of being included in the voice recognition apparatus 20, may be connected to the voice recognition apparatus 20 as an external output device such as a display audio. As an interface for connection, an interface compliant with a standard such as USB, HDMI®, or Bluetooth® can be used.

The positioner 26 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 26 measures the position of the voice recognition apparatus 20.

The functions of the voice recognition apparatus 20 are realized by execution of a program according to the present embodiment by a processor serving as the controller 21. That is, the functions of the voice recognition apparatus 20 are realized by software. The program causes a computer to execute the operations of the voice recognition apparatus 20, thereby causing the computer to function as the voice recognition apparatus 20. That is, the computer executes the operations of the voice recognition apparatus 20 in accordance with the program to thereby function as the voice recognition apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the voice recognition apparatus 20 may be realized by a programmable circuit or a dedicated circuit serving as the controller 21. That is, some or all of the functions of the voice recognition apparatus 20 may be realized by hardware.

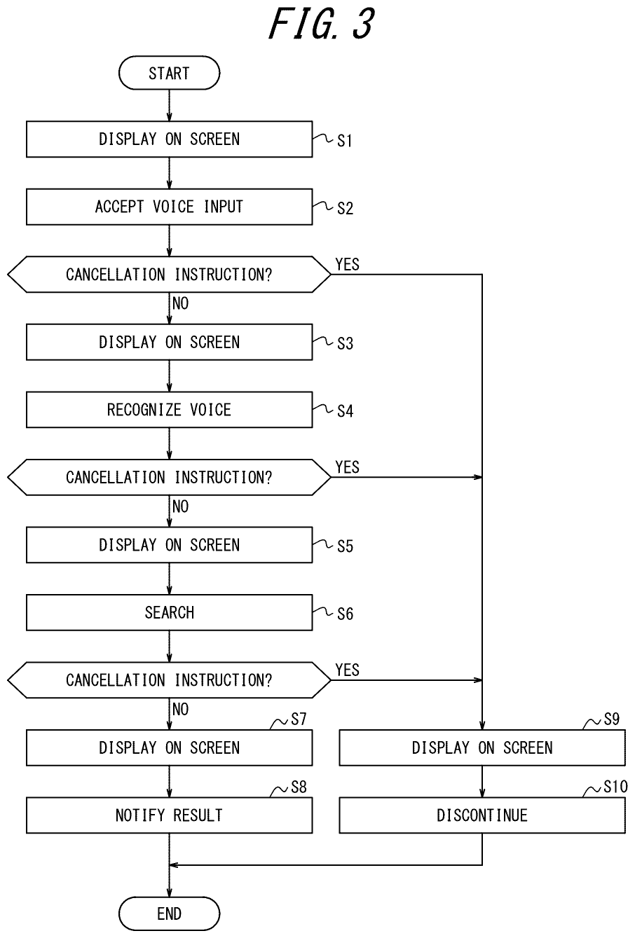

Operations of the voice recognition apparatus 20 according to the present embodiment will be described with reference to FIG. 3. The operations described below correspond to a control method according to the present embodiment. In other words, the control method according to the present embodiment includes steps S1 to S10 illustrated in FIG. 3.

When the user 11 issues a startup command such as “Hey, car!” or pressing a startup button displayed on a screen or disposed physically, step S1 is started.

In S1 to S8, the controller 21 controls the specific function Fp in response to voice input from the user 11. The specific function Fp is a function of a device installed in the vehicle 12, such as a navigation device or an audio device. Alternatively, the specific function Fp may be a function of the vehicle 12 itself.

The controller 21 sequentially transitions to each of the multiple states Ts within the transition period Pt from accepting the voice input until at least finishing controlling the specific function Fp. In the present embodiment, the transition period Pt is a period from accepting the voice input until notifying the user 11 of a result of controlling the specific function Fp. However, when the user 11 is not notified of the result, the transition period Pt may be a period from accepting the voice input until notifying the user 11 that the specific function Fp has been controlled.

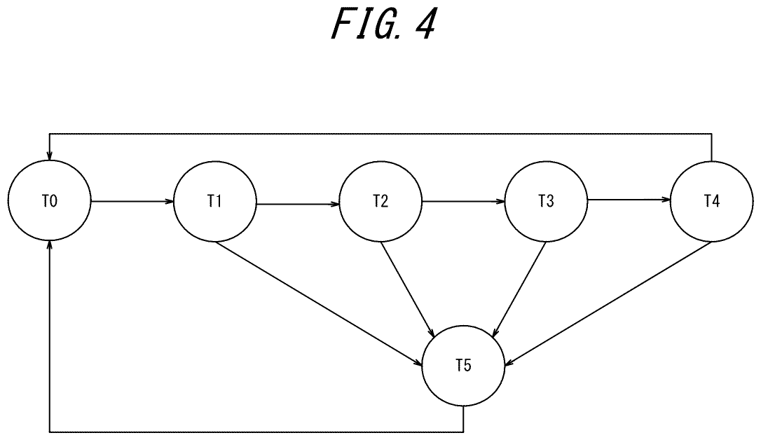

Each of the multiple states Ts is a state of the controller 21 and also a state of the voice recognition apparatus 20. In the present embodiment, the multiple states Ts include four states, among six states illustrated in FIG. 4, excluding an initial state TO and an exceptional state T5. In the order of state transitions, the first state T1 is a state in which the controller 21 is accepting the voice input. The second state T2 is a state in which the controller 21 is recognizing the voice input. The third state T3 is a state in which the controller 21 is searching in relation to controlling the specific function Fp. The fourth state T4 is a state in which the controller 21 is notifying the user 11 of the result of controlling the specific function Fp.

In S1, the controller 21 transitions from the initial state T0 to the first state T1. The controller 21 then displays, on the screen, as being in the first state T1. Specifically, the controller 21 displays a message such as “After user speech, start accepting” on a display as the output interface 25.

In S2, the controller 21 accepts the voice input from the user 11. Specifically, the controller 21 accepts the voice input, such as “I want to go to X” or “I want to listen to Y”, via the microphone as the input interface 24.

After S2, step S3 is started. However, in or before S2, when the user 11 issues a cancellation command such as “Stop” or presses a cancellation button displayed on the screen or disposed physically, step S9 is started. Both the user 11 issuing the cancellation command and the user 11 pressing the cancellation button correspond to cancellation instructions from the user 11.

In S3, the controller 21 transitions from the first state T1 to the second state T2. The controller 21 then displays, on the screen, as being in the second state T2. Specifically, the controller 21 displays a message such as “Recognizing” on the display as the output interface 25.

In S4, the controller 21 recognizes the voice input accepted in S2. As a specific method for voice recognition, a known method can be used. Machine learning, such as deep learning, may be used.

After S4, step S5 is started. However, in or before S4, when the user 11 issues the cancellation command or presses the cancellation button, step S9 is started.

In S5, the controller 21 transitions from the second state T2 to the third state T3. The controller 21 then displays, on the screen, as being in the third state T3. Specifically, the controller 21 displays a message such as “After recognition, searching” on the display as the output interface 25.

In S6, the controller 21 performs searching in relation to controlling the specific function Fp. Specifically, the controller 21 retrieves, from the memory 22, information required for controlling the function of the device installed in the vehicle 12, in response to the voice input recognized in S4. For example, upon recognizing the voice input “I want to go to X” in S4, the controller 21 searches for a route to X with reference to a map database built in the memory 22. Upon recognizing the voice input “I want to listen to Y” in S4, the controller 21 searches for Y with reference to a music database built in the memory 22. Alternatively, the controller 21 may retrieve, from the memory 22, information required for controlling the function of the vehicle 12 itself, in response to the voice input recognized in S4.

After S6, step S7 is started. However, in or before S6, when the user 11 issues the cancellation command or presses the cancellation button, step S9 is started.

In S7, the controller 21 transitions from the third state T3 to the fourth state T4. The controller 21 then displays, on the screen, as being in the fourth state T4. Specifically, the controller 21 displays a message such as “After search, displaying a result” on the display as the output interface 25.

In S8, the controller 21 notifies the user 11 of the result of controlling the specific function Fp. Specifically, the controller 21 controls, using the information retrieved in S6, the function of the device installed in the vehicle 12, and displays the result on the display as the output interface 25 or outputs the result audibly from the speaker as the output interface 25. For example, upon searching for the route to X in S6, the controller 21 sets the route to X on the navigation device and displays the route on the display. Upon searching for Y in S6, the controller 21 plays Y on the audio device and outputs Y through the speaker. Alternatively, the controller 21 may control, using the information retrieved in S6, the function of the vehicle 12 itself, and display the result on the display or output the result audibly from the speaker.

After step S8, the flow illustrated in FIG. 3 ends.

In S9, the controller 21 transitions to the exceptional state T5 from one of the first state T1, second state T2, third state T3, and fourth state T4. The controller 21 then displays, on the screen, as being in the exceptional state T5. Specifically, the controller 21 displays a message such as “Cancelling” on the display as the output interface 25.

In S10, the controller 21 discontinues controlling the specific function Fp. In other words, upon receiving the cancellation instruction from the user 11 during the transition period Pt, the controller 21 discontinues controlling the specific function Fp.

After step S10, the flow illustrated in FIG. 3 ends.

As described above, in S1 to S8, the controller 21 displays, on the screen, which of the multiple states Ts the controller 21 is in whenever transitioning from any one state of the multiple states Ts to another state. Thus, the user 11 can recognize the multiple states Ts between the voice input and the result notification. As a result, while the user 11 is using the voice recognition apparatus 20, it becomes easier for the user 11 to know the state of the voice recognition apparatus 20 after the voice input, which eliminates anxiety of the user 11.

The controller 21 may continuously display, on the screen, which of the multiple states Ts the controller 21 is in, during the transition period Pt. According to such an example, the user 11 can always check which state the voice recognition apparatus 20 is in between the voice input and the result notification.

In S1, S3, S5, or S7, when displaying, on the screen, which of the multiple states Ts the controller 21 is in, the controller 21 may use an image to represent which of the multiple states Ts the controller 21 is in. This image may include a gesture or a facial expression. For example, it is conceivable to display a character image with a nodding face in S1, a character image with a thinking expression in S2, a character image using a magnifying glass in S5, and a character image with a satisfied expression in S7. The character images may be animated.

In S1, S3, S5, or S7, when displaying, on the screen, which of the multiple states Ts the controller 21 is in, the controller 21 may output a voice message indicating which of the multiple states Ts the controller 21 is in. Specifically, the controller 21 may output the voice message, such as “After user speech, start accepting”, “Recognizing”, “After recognition, searching”, or “After search, displaying a result”, from the speaker as the output interface 25.

In S1, S3, S5, or S7, when displaying, on the screen, which of the multiple states Ts the controller 21 is in, the controller 21 may output different sound effects depending on which of the multiple states Ts the controller 21 is in. The sound effects are, for example, beeps.

As a variation of the present embodiment, the multiple states Ts may further include a state other than the first state T1 to the fourth state T4. For example, a sixth state T6 may be added between any two states. The sixth state T6 is a state in which the controller 21 is communicating with the server apparatus 30 in relation to controlling the specific function Fp.

For example, when the sixth state T6 is added between the third state T3 and the fourth state T4, the controller 21 transitions, after S6, from the third state T3 to the sixth state T6. The controller 21 then displays, on the screen, as being in the sixth state T6. Specifically, the controller 21 displays a message such as “Communicating” on the display as the output interface 25.

In this example, the controller 21 communicates with the server apparatus 30 in relation to controlling the specific function Fp. Specifically, the controller 21 requests additional information related to the information retrieved in S6, to the server apparatus 30 via the communication interface 23. The controller 21 then receives the requested additional information from the server apparatus 30 via the communication interface 23.

In S7, the controller 21 transitions from the sixth state T6 to the fourth state T4. In S8, the controller 21 controls, using not only the information retrieved in S6 but also the additional information received from the server apparatus 30, the function of the device installed in the vehicle 12 or the function of the vehicle 12 itself, and displays the result on the display as the output interface 25 or outputs the result audibly from the speaker as the output interface 25.

As another variation of the present embodiment, the multiple states Ts may not include any of the first state T1 to the fourth stateT4. For example, the third state T3 may be substituted with a state other than the first state T1 to the fourth state T4.

For example, when the third state T3 is substituted with the sixth state T6, the controller 21 transitions, in S5, from the second state T2 to the sixth state T6. The controller 21 then displays, on the screen, as being in the sixth state T6. Specifically, the controller 21 displays a message such as “Communicating” on the display as the output interface 25.

In S6, the controller 21 communicates with the server apparatus 30 in relation to controlling the specific function Fp. Specifically, the controller 21 requests, to the server apparatus 30 through the communication interface 23, information required for controlling the function of the device installed in the vehicle 12, in response to the voice input recognized in S4. The controller 21 then receives the requested information from the server apparatus 30 via the communication interface 23. For example, upon recognizing the voice input “I want to go to X” in S4, the controller 21 requests the server apparatus 30, through the communication interface 23, to search for a route to X. The controller 21 then receives, from the server apparatus 30 via the communication interface 23, information regarding the route to X. For example, upon recognizing the voice input “I want to listen to Y” in S4, the controller 21 requests the server apparatus 30, through the communication interface 23, to search for Y. The controller 21 then receives Y from the server apparatus 30 via the communication interface 23. Alternatively, the controller 21 may receive, from the server apparatus 30 through the communication interface 23, information required for controlling the function of the vehicle 12 itself, in response to the voice input recognized in S4.

In S7, the controller 21 transitions from the sixth state T6 to the fourth state T4. Specifically, the controller 21 controls, using the information received in S6, the function of the device installed in the vehicle 12 or the function of the vehicle 12 itself, and displays the result on the display as the output interface 25 or outputs the result audibly from the speaker as the output interface 25.

As yet another variation of the present embodiment, the multiple states Ts may include any number of states. For example, the multiple states Ts may include any one or more states, among the first state T1, second state T2, third state T3, sixth state T6, and fourth state T4.

The present disclosure is not limited to the embodiment described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.

[Appendix 1] A voice recognition apparatus comprising a controller configured to control a specific function in response to voice input from an occupant of a vehicle, the controller being configured to sequentially transition to each of multiple states within a transition period from accepting the voice input until at least finishing controlling the specific function, and display, on a screen, which of the multiple states the controller is in.
[Appendix 2] The voice recognition apparatus according to appendix 1, wherein the transition period is a period from accepting the voice input until notifying the occupant of a result of controlling the specific function.
[Appendix 3] The voice recognition apparatus according to appendix 1, wherein the transition period is a period from accepting the voice input until notifying the occupant that the specific function has been controlled.
[Appendix 4] The voice recognition apparatus according to any one of appendices 1 to 3, wherein when displaying, on the screen, which of the multiple states the controller is in, the controller uses an image to represent which of the multiple states the controller is in.
[Appendix 5] The voice recognition apparatus according to appendix 4, wherein the image includes a gesture or a facial expression.
[Appendix 6] The voice recognition apparatus according to any one of appendices 1 to 5, wherein when displaying, on the screen, which of the multiple states the controller is in, the controller outputs a voice message indicating which of the multiple states the controller is in.
[Appendix 7] The voice recognition apparatus according to any one of appendices 1 to 6, wherein when displaying, on the screen, which of the multiple states the controller is in, the controller outputs different sound effects depending on which of the multiple states the controller is in.
[Appendix 8] The voice recognition apparatus according to any one of appendices 1 to 7, wherein whenever transitioning from any one state of the multiple states to another state, the controller displays, on the screen, which of the multiple states the controller is in.
[Appendix 9] The voice recognition apparatus according to any one of appendices 1 to 7, wherein the controller is configured to continuously display, on the screen during the transition period, which of the multiple states the controller is in.
[Appendix 10] The voice recognition apparatus according to any one of appendices 1 to 9, wherein upon receiving a cancellation instruction from the occupant, during the transition period, the controller discontinues controlling the specific function.
[Appendix 11] The voice recognition apparatus according to any one of appendices 1 to 10, wherein the multiple states include a state in which the controller is accepting the voice input.
[Appendix 12] The voice recognition apparatus according to any one of appendices 1 to 11, wherein the multiple states include a state in which the controller is recognizing the voice input.
[Appendix 13] The voice recognition apparatus according to any one of appendices 1 to 12, wherein the multiple states include a state in which the controller is searching in relation to controlling the specific function.
[Appendix 14] The voice recognition apparatus according to any one of appendices 1 to 13, wherein the multiple states include a state in which the controller is communicating with a server apparatus in relation to controlling the specific function.
[Appendix 15] The voice recognition apparatus according to any one of appendices 1 to 14, wherein the multiple states include a state in which the controller is notifying the occupant of a result of controlling the specific function.
[Appendix 16] The voice recognition apparatus according to any one of appendices 1 to 15, wherein the specific function is a function of the vehicle or a device mounted on the vehicle.
[Appendix 17] A vehicle comprising the voice recognition apparatus according to any one of appendices 1 to 16.
[Appendix 18] A program configured to cause a computer to function as the voice recognition apparatus according to any one of appendices 1 to 16.
[Appendix 19] A control method comprising:
controlling, by a computer, a specific function in response to voice input from an occupant of a vehicle;
sequentially transitioning, by the computer, to each of multiple states within a transition period from accepting the voice input until at least finishing controlling the specific function; and
displaying, by the computer on a screen, which of the multiple states the computer is in.
   [Appendix 20] The control method according to appendix 19, wherein the multiple states include one or more states, among a state in which the computer is accepting the voice input, a state in which the computer is recognizing the voice input, a state in which the computer is searching in relation to controlling the specific function, a state in which the computer is communicating with a server apparatus in relation to controlling the specific function, and a state in which the computer is notifying the occupant of a result of controlling the specific function.

1. A voice recognition apparatus comprising a controller configured to control a specific function in response to voice input from an occupant of a vehicle, the controller being configured to sequentially transition to each of multiple states within a transition period from accepting the voice input until at least finishing controlling the specific function, and display, on a screen, which of the multiple states the controller is in.

2. The voice recognition apparatus according to claim 1, wherein the transition period is a period from accepting the voice input until notifying the occupant of a result of controlling the specific function.

3. The voice recognition apparatus according to claim 1, wherein the transition period is a period from accepting the voice input until notifying the occupant that the specific function has been controlled.

4. The voice recognition apparatus according to claim 1, wherein when displaying, on the screen, which of the multiple states the controller is in, the controller uses an image to represent which of the multiple states the controller is in.

5. The voice recognition apparatus according to claim 4, wherein the image includes a gesture or a facial expression.

6. The voice recognition apparatus according to claim 1, wherein when displaying, on the screen, which of the multiple states the controller is in, the controller outputs a voice message indicating which of the multiple states the controller is in.

7. The voice recognition apparatus according to claim 1, wherein when displaying, on the screen, which of the multiple states the controller is in, the controller outputs different sound effects depending on which of the multiple states the controller is in.

8. The voice recognition apparatus according to claim 1, wherein whenever transitioning from any one state of the multiple states to another state, the controller displays, on the screen, which of the multiple states the controller is in.

9. The voice recognition apparatus according to claim 1, wherein the controller is configured to continuously display, on the screen during the transition period, which of the multiple states the controller is in.

10. The voice recognition apparatus according to claim 1, wherein upon receiving a cancellation instruction from the occupant, during the transition period, the controller discontinues controlling the specific function.

11. The voice recognition apparatus according to claim 1, wherein the multiple states include a state in which the controller is accepting the voice input.

12. The voice recognition apparatus according to claim 1, wherein the multiple states include a state in which the controller is recognizing the voice input.

13. The voice recognition apparatus according to claim 1, wherein the multiple states include a state in which the controller is searching in relation to controlling the specific function.

14. The voice recognition apparatus according to claim 1, wherein the multiple states include a state in which the controller is communicating with a server apparatus in relation to controlling the specific function.

15. The voice recognition apparatus according to claim 1, wherein the multiple states include a state in which the controller is notifying the occupant of a result of controlling the specific function.

16. The voice recognition apparatus according to claim 1, wherein the specific function is a function of the vehicle or a device mounted on the vehicle.

17. A vehicle comprising the voice recognition apparatus according to claim 1.

18. A non-transitory computer readable medium storing a program configured to cause a computer to function as the voice recognition apparatus according to claim 1.

19. A control method comprising:
controlling, by a computer, a specific function in response to voice input from an occupant of a vehicle;
sequentially transitioning, by the computer, to each of multiple states within a transition period from accepting the voice input until at least finishing controlling the specific function; and
displaying, by the computer on a screen, which of the multiple states the computer is in.

20. The control method according to claim 19, wherein the multiple states include one or more states, among a state in which the computer is accepting the voice input, a state in which the computer is recognizing the voice input, a state in which the computer is searching in relation to controlling the specific function, a state in which the computer is communicating with a server apparatus in relation to controlling the specific function, and a state in which the computer is notifying the occupant of a result of controlling the specific function.
